(19) United States
(12) Patent Application Publication
(10) Pub. No.: US 2026/0092753 A1
(43) Pub. Date: Apr. 2, 2026

(54) RECOIL MODULE WITH A LINEAR MOTOR

(71) Applicant: HAPTECH, INC., New Orleans, LA (US)

(72) Inventor: Kyle MONTI, Luling, LA (US)

(21) Appl. No.: 19/340,989

(22) Filed: Sep. 26, 2025

Related U.S. Application Data
(60) Provisional application No. 63/700,254, filed on Sep. 27, 2024.

(51) Int. Cl. F41A 21/38; B64D 7/02; B64U 10/16; B64U 20/80; B64U 101/18

(52) U.S. Cl. CPC F41A 21/38; B64D 7/02; B64U 10/16; B64U 20/80; B64U 2101/18; B64U 2201/10; B64U 2201/20

(57) ABSTRACT

A recoil module for a firearm or a firearm simulator is configured to generate forces that simulate the forces generated by firing a live round of ammunition or that help to cancel or reduce the forces generated by firing a live round of ammunition. Such a recoil module could be mounted in or on an actual firearm, a firearm simulator or a flying drone that carries or is integrated with a firearm.

This application claims priority to the Sep. 27, 2024 filing date of U.S. Provisional Patent Application No. 63/700,254, the contents of which are incorporated herein by reference.

### FIELD OF THE INVENTION

The invention relates to firearms and firearm simulators used in connection with firearms training.

### BACKGROUND OF THE INVENTION

One way of effectively conducting firearm training is to use live ammunition and to fire the live ammunition at a target. However, there are many drawbacks to using live ammunition in firearm training. The cost of using live ammunition is one immediate drawback. A second drawback is the danger inherent in using live ammunition. Also, for safety reasons it is impossible to use live ammunition when conducting training that might involve one individual aiming or firing at another individual.

Because of the drawbacks to using live ammunition, there have been efforts to create firearm simulators, which are devices that resemble actual firearms, but which are configured so that they do not use live ammunition. A firearm simulator may include one or more mechanisms that provide an indication of what the user would have hit if the user had been firing live ammunition. For example, a laser can be mounted on the firearm simulator, where the laser is configured to emit a pulse of laser radiation when the user pulls a trigger of the firearm simulator. One or more sensors in a training area can then detect where the pulse of radiation was directed.

To provide a more realistic training environment, some firearm simulators also incorporate one or more recoil mechanisms that simulate the recoil forces that a user experiences when firing live ammunition. The firearm simulator can include a controller that both triggers a laser to emit a pulse of radiation and causes the recoil mechanism to generate recoil forces when the user pulls the trigger of the firearm simulator. The recoil mechanism may be capable of generating a variety of different recoil force profiles that correspond to firing different types of ammunition from the same type of firearm. Similarly, the recoil mechanism may be capable of generating a variety of different recoil force profiles that correspond to firing different types of firearms and/or different types of firearms firing a variety of different types of ammunition. Thus, a single firearm simulator can be used to conduct realistic firearms training for a variety of different actual firearms, or for a single firearm capable of firing a range of different types of ammunition.

The recoil mechanisms that generate forces that mimic recoil can include one or more linear motors that incorporate a sliding mass. Such mechanical devices may also include a strike plate that a sliding mass impacts to provide realistic recoil forces.

Examples of firearm simulators that include recoil mechanisms are disclosed in U.S. Pat. Nos. 9,146,069 and 10,852,093, the contents of both of which are incorporated herein by reference.

### BRIEF DESCRIPTION OF THE DRAWINGS

FIG. 1 is a diagram of one embodiment of a linear actuator.

FIG. 2 is a partial perspective view of an embodiment of a movable member of a linear actuator.

FIG. 3 is an enlarged, partial perspective view of a movable member of a linear actuator.

FIG. 4 is a diagram illustrating how multiple coils of a stator of a linear actuator can be electrically connected to one another.

FIG. 5 is a diagram illustrating one example of how magnets and electrical coils of a linear actuator can be arranged.

FIG. 6 is a diagram illustrating another example of how magnets and electrical coils of a linear actuator can be arranged.

FIG. 7 is a diagram illustrating one example of how magnets and electrical coils of a linear actuator can be arranged.

FIG. 8 is a diagram illustrating one example of how magnets and electrical coils of a linear actuator can be arranged.

FIG. 9 illustrates the elements of an embodiment of a recoil module.

FIGS. 10A and 10B illustrate an embodiment of a recoil module that includes two linear actuators.

FIGS. 11A and 11B illustrate another embodiment of a recoil module that includes three linear actuators.

FIG. 12 is a perspective view of a first embodiment of a firearm with an integral recoil module.

FIG. 13 is a perspective view of a second embodiment of a firearm with an externally mounted recoil module.

FIG. 14 is a perspective view of a drone with a firearm that incorporates at least one recoil module.

FIG. 15 is a perspective view of a drone with a linear actuator unit as a payload.

### DETAILED DESCRIPTION

The disclosed apparatus, systems and methods make use of one or more recoil modules that can be configured to perform one or multiple different functions. Such a recoil module can be mounted on or incorporated into a dedicated firearm simulator so that the recoil module can generate recoil forces to simulate the forces that would be generated when firing live ammunition. The recoil module could be configured to generate a variety of different recoil force profiles to simulate the recoil forces generated by multiple different types of actual firearms, or the recoil forces that are generated when a single actual firearm fires different types of ammunition.

A recoil module also could be mounted on or incorporated into an actual firearm so that the actual firearm could be used as a firearm simulator to conduct training. In other words, the user of an actual firearm could deliberately choose to not fire live ammunition during training exercises, and instead cause the recoil module to generate recoil forces to simulate the feel of firing live rounds of ammunition. Because the user would then be holding and using an actual firearm, instead of a firearm simulator, the training could be more realistic.

A recoil module might also be configured to generate forces that counteract the forces generated when a user fires a live round of ammunition. When a recoil module is mounted on an actual firearm, pulling the trigger of the firearm could trigger the firing of a live round of ammunition and cause the recoil module to generate forces designed to counteract the forces generated by firing the live round of ammunition. This would help to keep the actual firearm steady in the user's hands between firing actions.

For example, the recoil module could substantially cancel the recoil forces generated by firing a live round of ammunition that tends to cause the end of the barrel of the firearm to rise. This would help the user to keep the firearm pointed at a particular target when firing multiple rounds of live ammunition. Similarly, it may be possible for the recoil module to partially or substantially cancel the recoil forces that tend to cause the firearm to move backwards. Here again, this would help the user to maintain good control over the actual firearm when firing multiple rounds of live ammunition.

In some embodiments, the recoil module may be configured to counteract only some aspects or components of the recoil forces that are generated when a user fires a round of live ammunition. For example, the recoil forces that are generated when a user fires a round of live ammunition could include a first translational component that acts to push the firearm directly backward from the aiming direction and a second rotational component that tends to cause the firearm to rotate around its center of mass such that the end of barrel of the firearm tends to move upward.

A recoil module installed in or mounted to a firearm may be configured to counteract only the rotational component of the recoil force so that when the user fires a round of live ammunition the firearm does not tend to rotate around its center of mass and such that the end of the barrel of the firearm does not tend to move upward. Alternatively, the recoil module could be configured to counteract only the translational forces generated when a live round of ammunition is fired that tend to push the firearm backwards from the aiming direction.

Of course, in other embodiments, the recoil module could be configured to substantially cancel both the rotational and the translational recoil force components that result from firing a live round of ammunition. Further, a recoil module could be configured to partially cancel one of the rotational and translational components and substantially cancel all of the other of the translational and rotational components of the recoil force generated when firing a live round of ammunition.

In some embodiments, the way in which a recoil module partially or substantially fully cancels the rotational and translational components of the recoil force that is generated when firing a live round of ammunition may be selectively adjustable by the user. This would allow the user to “tune” the recoil module to provide only the effects that the user finds desirable or helpful.

Further, the ability to selectively adjust the way in which a recoil module acts to cancel the recoil forces generated when firing a live round of ammunition may allow a user to mount a recoil module to a new type of actual firearm where a recoil module has not previously been used, and to then tune the recoil module to cancel the rotational and translational components of the recoil force that is generated when firing a live round of ammunition in the new actual firearm.

A small recoil module may be attached to or installed in an actual firearm or in a firearm simulator. In some embodiments, the recoil mechanism could include a single linear motor with a sliding mass. In other embodiments multiple linear motors could be employed in the recoil module, with each linear motor being oriented in a different direction so that selective movements of the sliding masses of two or more linear motors can be combined to generate complex recoil forces acting in multiple linear and rotational directions, or complex forces configured to counteract the recoil forces generated when an actual firearm fires a live round of ammunition.

In some embodiments, the recoil module could include additional elements that provide an indication of where the firearm is aimed when the user pulls the trigger. For example, the recoil module could include a laser that emits a beam of laser radiation in the direction the firearm is aimed when the user pulls the trigger, in addition to generating an appropriate recoil force or forces designed to counteract the forces generated when firing a live round of ammunition.

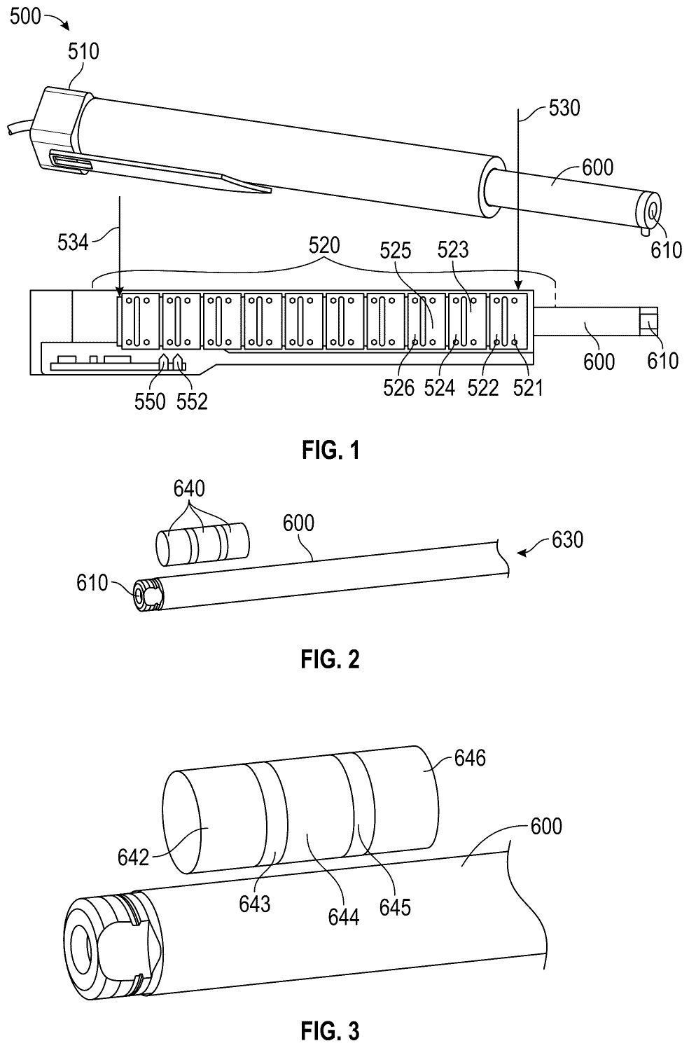

As mentioned above, a recoil module can make use of one or more linear motors that are actuated to generate forces that simulate the recoil forces generated when firing a round of live ammunition, or forces configured to counteract one or more of the recoil forces that are generated by firing a round of live ammunition. FIGS. 1-8 help to illustrate the type and configuration of a linear motor that could be used in such a recoil module.

FIG. 1 is a perspective view of a linear motor 500 and that includes a sliding mass 600 mounted inside a stator that includes a plurality of electrical coils 520. FIG. 2 is a perspective view of a first embodiment of a sliding mass 600 that can be used in the linear motor 500 of FIG. 1. The sliding mass 600 includes a plurality of magnets 640 separated by spacers.

The Linear motor 500 may include a plurality of separately controllable electrical coils 521, 522, 523, 524, 525, 526, etc. which may electromagnetically interact with a plurality of magnets 640 on the sliding mass 600. By controlling the timing, direction of current, and power of magnetic attraction of particular magnetic coils in the plurality of separately controllable magnetic coils 520, movement, acceleration, velocity, and position of the sliding mass 600 may be controlled to obtain a desired momentum/impulse curve over time which approximates a particular impulse curve over time for a particular firearm being simulated.

In some embodiments, the sliding mass 600 may include an outer shell that holds the plurality of magnets and spacers securely together. In an embodiment, the outer shell may be stainless steel, which may be a non-magnetic material that does not substantially interfere with the magnetic forces between the plurality of coils 520 of linear motor 500 and the plurality of magnets 640 of the sliding mass 600.

FIG. 3 is an enlarged perspective view of another embodiment of a sliding mass 600. In this embodiment, a plurality of magnets 642, 644, 646 are separated by spacers 643, 645. Each of the magnets 642, 644, 646 may be the same type of magnet, or each of the magnets may be of a different type. For example, the magnets may be some combination of neodymium magnets and ceramic magnets. In some embodiments, the spacers 643, 645 may include iron (such as ferromagnetic iron). In some embodiments, the plurality of magnets 642, 644, 646 may be aligned so that like poles face like poles (i.e., north pole to north pole and south pole to south pole).

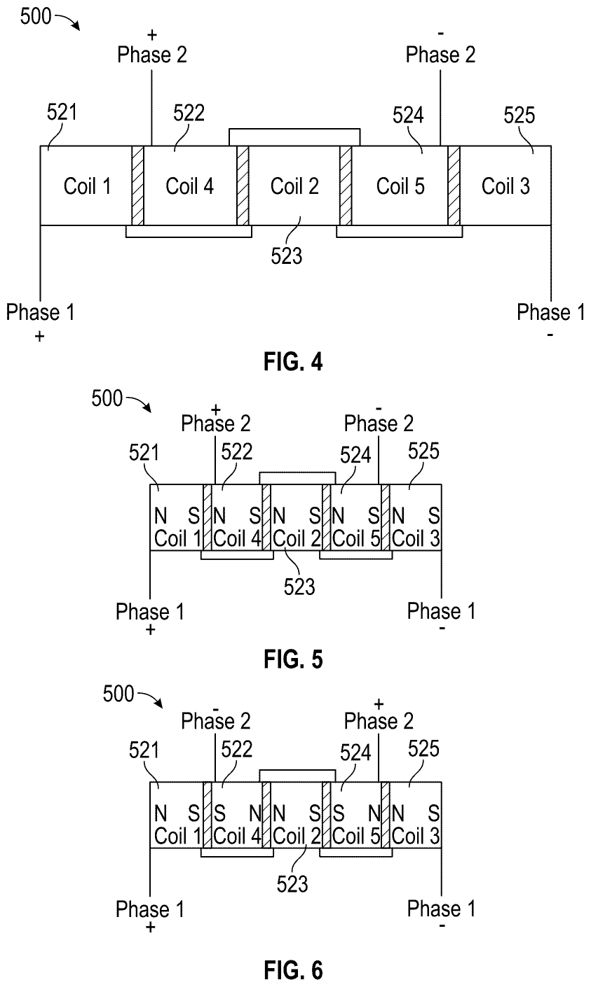

FIGS. 4 to 8 schematically show operation of linear motor 500 and sliding mass 600 as the plurality of magnets 640 are driven by the plurality of coils 520. FIG. 4 is a schematic diagram illustrating the operation of the plurality of coils 520 in a linear motor 500. FIGS. 5 and 6 are schematic diagrams illustrating operation of the coils 520 in a linear motor 500 in two different energized states.

In FIG. 4, coils 521, 523, and 525 in the stator of linear motor 500 may be wired in series and labeled as phase 1. When wired together in series these coils of phase 1 may be considered sub-coils of a single independently controllable magnetic coil. Coils 522 and 524 may also be wired in series and labeled as phase 2. When wired together in series these coils of phase 2 may be considered sub-coils of a single independently controllable magnetic coil. Additionally, there can be an arrangement of two coils represented by phase 1 and phase 2 and these coils may be wound separately across the stator body or overlapping each other.

The plurality of independently controllable magnetic coils 520 of linear motor 500 may be wound in the same or different direction depending on design. Each independently controllable coil in phase 1 and phase 2 may produce its own magnetic field when energized. This allows for independently controllable magnetic coils of phase 1 and phase 2 in the plurality of coils 520 to repel each other or for phase 1 and phase 2 coils to attract each other depending on the way the phases are polarized and the coils wound. These alternative states of polarization are shown in FIGS. 5 and 6.

In FIG. 5, phase 1 and phase 2 are polarized in the same direction so that coils in the two phases are attracted to each other. In FIG. 6, phase 1 and phase 2 are polarized in the opposite direction so that coils in the two phases repel each other. By varying the polarization of phases in the plurality of independently controllable magnetic coils 520 of linear motor 500, the sliding mass 600 may be controllably moved as desired through the plurality of coils 520 so as to create the desired reactive forces which may include time dependent controlled force (impulse), acceleration, velocity, position, and/or momentum.

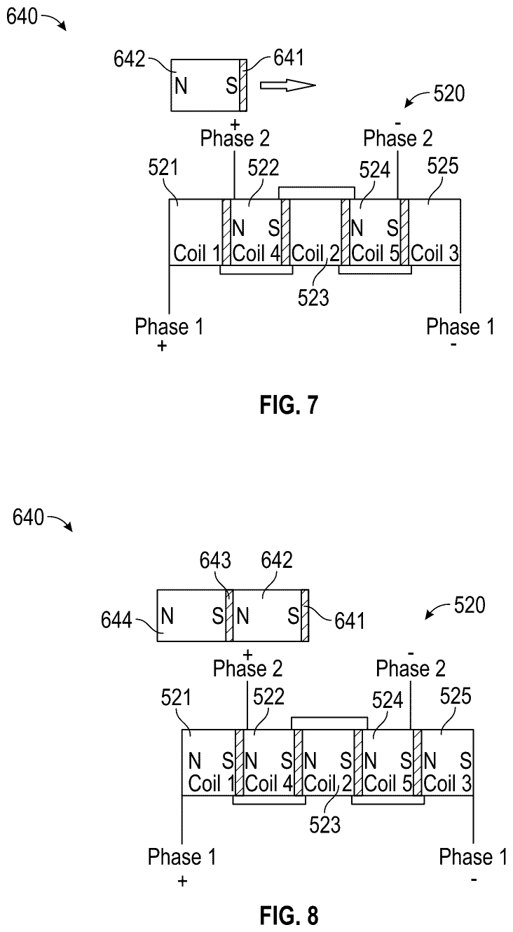

FIGS. 7 and 8 are schematic diagrams illustrating movement of the plurality of magnets 640 of sliding mass 600 through the plurality of coils 520 in linear motor 500 in different energized states. FIG. 7 schematically indicates initial movement of sliding mass 600 with the plurality of magnets 640 through the plurality of coils 520 of the linear motor 500. In FIG. 7, the first magnet 642 of the sliding mass 600 enters the plurality of coils 520 of the linear motor 500. The plurality of coils 520 may then be energized with phase 2 polarized as shown and phase 1 not being energized (or OFF). This causes magnet 642 (and sliding mass 600) to be pulled deeper into plurality of coils (schematically indicated by the arrow towards the right). As schematically shown in FIG. 8, when first magnet 642 moves halfway into coil 522, phase 1 may be energized (or turned ON), thereby creating a pulling force on magnet 642 and speeding the second magnet 644 to the center of coil 521 while at the same time repelling the magnet 642. The movement of sliding mass 600 eventually stops when the plurality of magnets 640 reach steady state with the plurality of coils 520, which in this case means that the north pole of coils 521 and 522 are aligned with the north poles of magnets 644 and 642, respectively; and north pole of coil 522 is aligned with south pole of magnet 644 and south pole of coil 521 is aligned with the north pole of magnet 642. Thus, the magnetic forces are in equilibrium and movement ceases while phase 1 and 2 remain energized with this polarization. So, by switching the coils ON/OFF and by alternating the coils polarization, the slider (filled with neodymium magnets) may be pushed or pulled through the stator (made up of many coils). Furthermore, the number of coils depicted in FIGS. 4 through 8 may be increased to have a larger accelerating cross-section.

In one embodiment, there may be two or more phases in linear motor 500. In another embodiment, two phases in linear motor 500 may use two or more coils 520. As depicted in FIG. 1, the linear movement, velocity and acceleration of sliding mass 600 may be measured as a function of the signals output by two Hall Effect sensors 550 and 552 that are 90 degrees out of phase. Out of phase Hall Effect sensors 550 and 552 may each produce a linear voltage in response to increasing or decreasing magnetic fields.

Additional details of how a linear motor can be configured and how a linear motor can be actuated to provide recoil forces can be found in U.S. Pat. No. 10,852,093, the contents of which are incorporated herein by reference.

The same forces generated by a linear motor to simulate recoil forces can be generated to counteract the recoil forces that are generated when a live round of ammunition is fired. Generally speaking, it is a matter of causing the linear motor to generate one or more forces that are in opposition to the force or forces that are generated when a round of live ammunition is fired.

Because the recoil forces that are generated when a live round of ammunition is fired can include components acting in multiple directions or that include one or more rotational components, it is also possible to use multiple linear motors to generate multiple force components that together effectively counteract one or more of the forces generated when a live round of ammunition is fired. These concepts are explored in greater detail below.

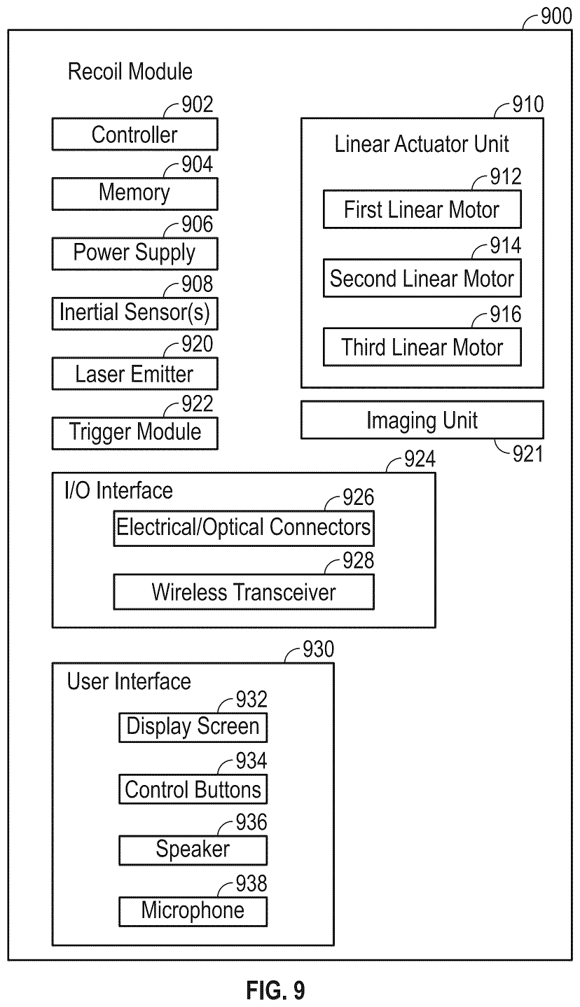

FIG. 9 is a block diagram that illustrates multiple components of a recoil module 900 that can be configured to counteract one or more components of the recoil forces that are generated when a firearm fires a live round of ammunition. The same recoil module 900 could also generate recoil forces that simulate the recoil forces that are generated when the firearm fires a live round of ammunition. As a result, when a recoil module 900 as depicted in FIG. 9 is mounted in or on an actual firearm, the recoil module 900 can generate recoil forces that simulate what a user would feel when firing a live round of ammunition in order to conduct training with the actual firearm. Alternatively, the recoil module 900 could generate forces intended to cancel or suppress the recoil forces that are generated when the actual firearm fires a live round of ammunition to limit or substantially cancel movement of the firearm system.

The recoil module 900 includes one or more controllers 902 that control various functions of the recoil module 900, and in particular the forces that are generated by actuation of the recoil module. A memory 904 connected to the controller(s) 902 can store various items of information, as well as data and programs that are used by the controller(s) 902 to control actuation of the recoil module 900.

A power supply 906 powers some or all of the other components of the recoil module 900. The power supply 906 could be permanently mounted in the recoil module 900, or the power supply 906 could be a separate unit that is removably mounted to the recoil module 900. If the power supply 906 is permanently mounted to the recoil module 900, a power charging port in the form of an electrical connector or an inductive charging element may be provided on the power supply 906 so that the power supply 906 can be recharged.

The recoil module 900 also includes a linear actuator unit 910 that includes at least one linear motor. In some embodiments, the linear actuator unit 910 may include only a first linear motor 912. In other embodiments, a second linear motor 914 and possibly a third linear motor 916 may be included in the linear actuator unit 910. Details of how two or three linear motors can be combined into a single linear actuator unit 910 are provided below.

The recoil module 900 may include one or more inertial sensors 908 that are configured to sense movements of the recoil module 900. The inertial sensors 908 could include one or more accelerometers, gyroscopes, piezoelectric transducers or other sensors that are capable of detecting acceleration, velocity, rotation and/or motion. The inertial sensors 908 can be used to provide feedback to the controller(s) 902 to help the controller(s) 902 effectively control the linear actuator unit 910 to generate recoil forces or to counteract recoil forces that are generated when a firearm fires a round of live ammunition. The inertial sensors 908 could also detect and report on movements of a firearm simulator or an actual firearm to which the recoil module 900 is mounted. Such information on movements of the firearm simulator or actual firearm could be stored and reported as part of training exercises or to report on a history of what occurred as the firearm simulator or actual firearm was used for various purposes.

Information or signals generated by the inertial sensors 908 could be used to improve upon the recoil forces generated by the linear actuator unit 910 to make the recoil forces simulating the firing of a live round of ammunition more realistic or accurate. Also, information and signals generated by the inertial sensors 908 could be used to adjust the forces generated by the linear actuator unit 910 to more effectively or accurately counteract the forces that are generated by firing a live round of ammunition.

For example, if the recoil module 900 is mounted on an actual firearm, the user could test fire one or more live rounds of ammunition while the output of one or more inertial sensors 908 is monitored and recorded. Thereafter, the controller(s) 902 can selectively actuate one or more linear motors of the linear actuator unit 910 while also monitoring and recording the signals output by one or more inertial sensors 908. The controller(s) 902 could then selectively vary the actuation of the linear motors of the linear actuator unit 910 until the signals output by the inertial sensors 908 when the linear actuator unit 910 is actuated approximate the signals that the inertial sensors 908 output when live rounds of ammunition were fired. Thus, by a process of trial and error or selective tuning, the controller(s) 902 can determine how to actuate the linear actuator unit 910 so that the linear actuator unit provides recoil forces that mimic the recoil forces generated by firing live rounds of ammunition.

This same process could be repeated using a second different type of live ammunition so that the controller(s) 902 can determine how to actuator the linear actuator unit 910 to generate recoil forces that mimic the recoil forces that are generated when the second type of live ammunition is fired.

In a similar fashion, the processor(s) 902 may be configured to monitor the signals output by one or more inertial sensors 908 while live rounds of ammunition are fired, while at the same time selectively actuating the linear motors of the linear actuator unit 910 to determine how actuation of the linear motors affects motion of the firearm when live rounds of ammunition are being fired. In this way, the processor(s) 903 can determine how (both timing and amplitude) to actuate the linear motors of the linear actuator unit 910 to partially or substantially fully cancel one or more components of the recoil forces that are generated when firing live rounds of ammunition.

For example, if one of the inertial sensors 908 outputs a signal that represents a translational movement of the firearm that occurs when a live round of ammunition is fired, then the processor(s) 902 could selectively actuate one or more of the linear motors of the linear actuator unit 910 when live rounds of ammunition are fired until the processor(s) 902 determine the pattern of actuation of the linear motors of the linear actuator unit 910 that will cause the signal output by the inertial sensor 908 to be substantially zero.

This same process could be conducted to determine the pattern of actuation of the linear motors of the linear actuator unit 910 that will cause the signals output by one or more inertial sensors 908 that output a signal representative of a rotational component of recoil to be substantially zero.

The above process can be repeated as necessary to determine how to actuate the linear motors of the linear actuator unit 910 to selectively reduce or substantially cancel one or more of the force components of recoil generated when a live round of ammunition is fired. Similarly, the process can be repeated for a second different type of ammunition to determine how to actuate the linear motors of the linear actuator unit 910 to selectively reduce or substantially cancel one or more of the force components of recoil generated when a the second type of live ammunition is fired.

Machine learning algorithms being run by the processor(s) 902 can help this overall process of learning how to actuate the linear motors of the linear actuator unit 910 to adjust or tune a particular recoil module 900 for use on a particular actual firearm that is firing a specific type of ammunition.

The recoil unit 900 may also include a laser emitter 920. When the recoil unit 900 is mounted on a firearm or firearm simulator, the laser emitter 920 would be configured to emit laser radiation in a direction in which the firearm or firearm simulator is pointed when the user pulls a trigger. This would allow the firearm or firearm simulator to be used in training exercises.

The recoil unit 900 may also have an imaging unit 921, which could take the form of a digital camera or a stereoscopic camera. The imaging unit 921 would be configured to capture an image of what the firearm is aimed at when firing operations take place. Analysis of the resulting image or images can provide information about how well a user was aiming the firearm during a training or live fire action.

Some embodiments of the recoil unit 900 may include a trigger module 922 that is configured to determine when a user pulls a trigger of a firearm or firearm simulator to which the recoil module 900 is attached. The trigger module 922 could be configured to detect when the real trigger of an actual firearm is actuated, or when the trigger of a firearm simulator is actuated. In some embodiments, the trigger mechanism of an actual firearm may be replaced with the trigger module 922 of the recoil unit 900 as part of a process of converting the actual firearm into a firearm simulator. In other instances, the trigger module 922 is simply configured to detect when a separate trigger has been actuated.

The recoil module 900 may also include an input/output interface 924. The input/output interface 924 is configured to receive external signals that provide information and instructions about how the recoil module 900 is to perform. The input/output interface 924 could include one or more electrical or optical connectors 926 designed to communicate electrical or optical signals. The input/output interface 924 could also include a wireless transceiver 928, such as a Bluetooth transceiver, a WiFi transceiver or other typical radio transceivers that are used to communicate with flying drones.

The input/output interface 924 could be used to receive a trigger signal indicating when to actuate the linear actuator unit 910 to generate simulated recoil forces or to generate forces designed to counteract forces generated when an actual firearm fires a round of live ammunition. The input/output interface 924 could also receive information or data about force profiles that allow the linear actuator unit 910 to generate recoil forces corresponding to a particular firearm and a particular type of ammunition. Such information could then be stored in the memory 904. Thus, new information about new force profiles could be downloaded into the memory 904 via the input/output interface 924 to allow the recoil module 900 to simulate new recoil forces or to counteract the forces generated by firing a live round of ammunition.

The input/output interface 924 could also be used to report information to an external system. For example, information and data generated by the controller 902 and/or generated by the inertial sensors 908 as a user conducts training or conducts actual firing actions with a firearm simulator or an actual firearm to which the recoil module 900 is mounted could be reported to an external system via the input/output interface 924. Such information could be used by the external system to generate new control signals or new force profile data that is then downloaded back into the recoil module 900 via the input/output interface 924 to allow the recoil module 900 to operate more effectively or accurately. Similarly, the input/output interface 924 could be used to output image data captured by the imaging unit 921.

The recoil module 900 may further include a user interface 930. The user interface 930 may include a display screen 932, and the display screen may be touch-sensitive so that the touch-sensitive display screen 932 could also be used to receive user input. The user interface 930 may further include control buttons 934, a speaker 936 and a microphone 938. The user interface 930 could be used to communicate settings and other information to the user. The user interface 930 could also be used to receive input from user that is used to alter settings and operations of the recoil module 900.

In some embodiments, the user interface 930 may make use of the wireless transceiver 928 of the input/output interface 924 to communicate with a software application running on a computing device, such as a laptop computer or a smartphone. The user could then operate the software application to communicate with the recoil module 900 in order to setup the recoil module 900 and to alter its settings and operations.

The depiction of a recoil module 900 in FIG. 9 should in no way be considered limiting. Some embodiments of a recoil module 900 may not include all the elements depicted in FIG. 9, and some embodiments of a recoil module 900 may include elements other than those shown in FIG. 9.

As noted above, a recoil module 900 may include a linear actuator unit 910 with only a single linear motor 912. In that instance, the recoil module 900 may be mounted in or on a firearm simulator or an actual firearm in such a way that the single linear motor 912 generates forces acting in a very specific direction. In some instances, this could result in the single linear motor 912 generating a recoil force that simulates multiple force components that are generated when firing a live round of ammunition. In other instances, this could result in the single linear motor 912 generating one or only a few of the force components that would be generated upon firing a live round of ammunition.

Likewise, a recoil module 900 including a single linear motor 912 may orient the single linear motor 912 on an actual firearm so that actuation of the linear motor 912 generates multiple force components intended to cancel or counteract multiple force components that are generated when the actual firearm fires a live round of ammunition. Alternatively, the single linear motor 912 may be oriented and actuated in such a way that it cancels or counteracts only one or only a few of the force components that are generated when firing a live round of ammunition.

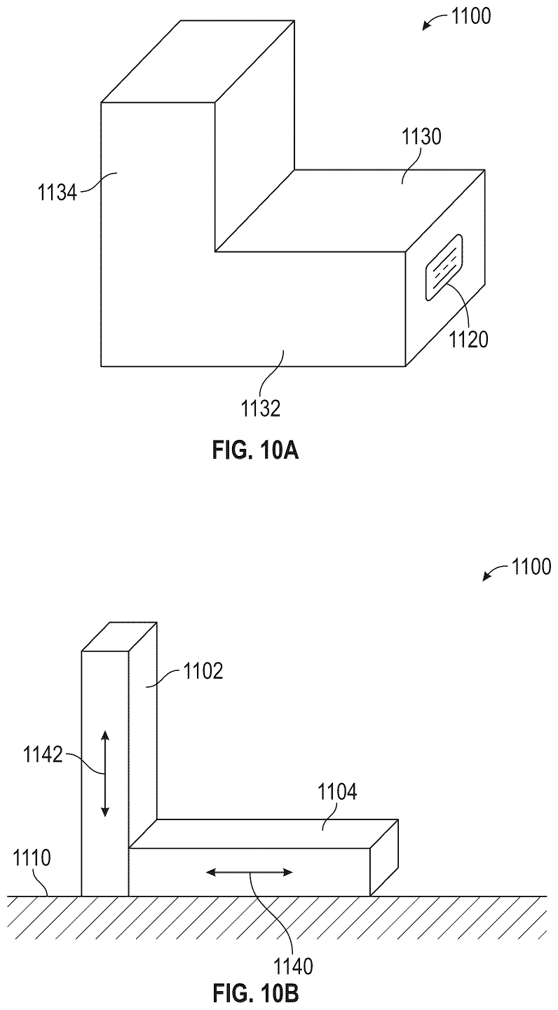

A recoil module 900 may also include two linear motors 912, 914 that allow the recoil module 900 to generate forces that simulate recoil forces including multiple force components acting in multiple directions or rotational orientations. FIGS. 10A and 10B illustrate a recoil module 1100 that includes a first linear motor module 1102 oriented in a first direction and a second linear motor module 1104 oriented in a second different direction. In the embodiment depicted in FIGS. 10A and 10B, the actuation or movement direction of the first linear motor module 1102 is oriented at 90 degrees with respect to the actuation or movement direction of the second linear motor module 1104. The first linear motor module 1102 is capable of generating reaction forces that a directed in the direction of arrows 1142. The second linear motor module 1104 is capable of generating reaction forces that act in the direction of arrows 1140. By selectively actuating both linear motor modules 1102, 1104, one can cause reaction forces that have multiple components acting in multiple different linear and rotational directions. The direction of the forces generated by each linear motor module 1102, 1104, the strength of the forces generated by each linear motor module 1102, 1104 and the timing of the forces generated by each linear motor module 1102, 1104 can all be controlled to generate a variety of different force profiles that include multiple different force components. The point is that a linear actuator unit 1100 including two linear motor modules 1102, 1104 can generate a great variety of force components that would not be possible with a linear actuator unit 910 that includes only a single linear motor module.

FIG. 10A shows the first linear motor module 1102 and the second linear motor module 1104 packaged inside an L-shaped housing 1130. The first linear motor module 1102 is located inside a first leg 1134 of the housing 1130 and the second linear motor module 1104 is located inside a second leg 1132 of the housing 1130. An electrical and/or optical connector 1120 is provided on the side of the second leg 1132 of the housing.

In some embodiments, the housing 1130 may enclose only the two linear motor modules that make up a linear actuator unit 910 of a recoil module 900. In other embodiments, the housing 1130 may enclose all the other elements that make up a recoil module 900. Thus, the housing 1130 shown in FIG. 10A may be the housing for the entire recoil module 900. In which case, the connector(s) 1120 shown in FIG. 10A would be the electrical/optical connectors 926 of the input/output interface 924 of the recoil module 900.

Although the embodiment shown in FIGS. 10A and 10B have the first and second linear motor modules 1102, 1104 oriented 90 degrees apart and in essentially the same plane, in other embodiments this may not be the case. For example, the first linear motor module 1102 may be offset from the second linear motor module 1104 so that the two linear motor modules 1102, 1104 are not in essentially the same plane. This could help in generating certain reaction forces that include rotational components.

Other embodiments could also have the first and second linear motor modules 1102, 1104 oriented at something other than 90 degrees with respect to each other. Also, some embodiments could have the first and second linear motor modules 1102, 1104 both offset into different planes and oriented at something other than 90 degrees apart. Further, the second linear motor module 1104 may be oriented such that the force components it can generate, as reflected by the arrows 1140 extend in a plane that is oriented at an angle with respect to the plane in which the force components generated by the first linear motor module 1102 act, as reflected by the arrows 1142.

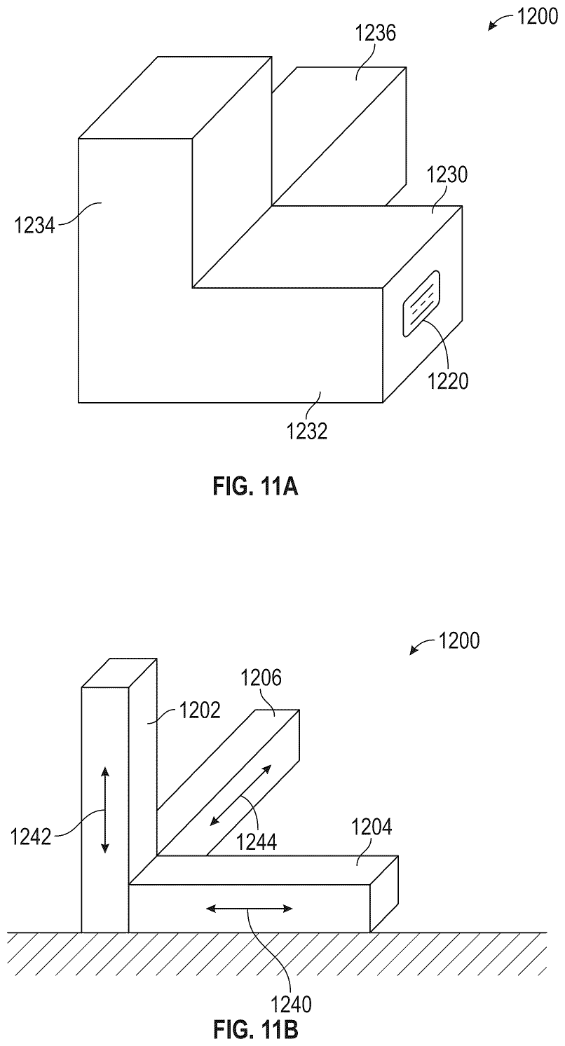

FIGS. 11A and 11B illustrate another embodiment of a recoil module 900 or a linear actuator unit 910 that includes three linear motor modules 1202, 1204, 1206. This embodiment is similar to the one depicted in FIGS. 10A and 10B, except that it includes a third linear motor module 1206 having a movement or actuation direction that is oriented at 90 degrees with respect to both the first linear motor module 1202 and the second linear motor module 1204. The first linear motor module 1202 generates force components acting in the direction of arrows 1242. The second linear motor module 1204 generates force components acting in the direction of arrows 1240. The third linear motor module 1206 generates force components acting in the direction of arrows 1244.

The addition of a third linear motor module 1206 oriented at a different direction with respect to the first linear motor module 1202 and the second linear motor module 1204 allows the linear actuator unit 1200 to generate additional force components and combinations of force components that would not be possible when only two linear motor modules are provided. Here again, the amount of the forces generated, the directions of the forces and the timing of the forces generated by each of the first, second and third motor modules 1202, 1204, 1206 can be selectively varied to generate a great variety of force components.

FIG. 11A shows that the first linear motor module 1202 would be located within a first leg 1234 of a housing 1230. The second linear motor module 1204 would be located within a second leg 1232 of the housing 1230. The third linear motor module 1206 would be located within a third leg 1236 of the housing 1230. The housing 1230 also includes one or more electrical or optical connectors 1220. As with the previous embodiment, the housing 1230 could enclose only a linear actuator unit 910 of a recoil module 900. Alternatively, the housing 1230 could include all the components of a recoil module 900.

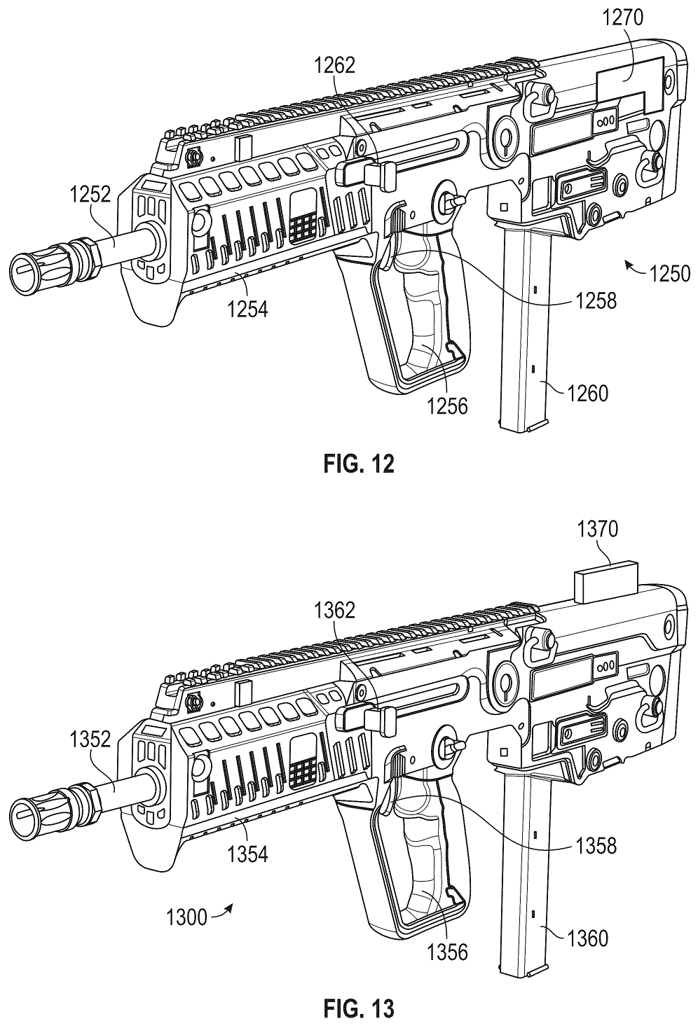

FIG. 12 illustrates what could be an actual firearm or a firearm simulator 1250. The firearm/firearm simulator 1250 includes a first handle 1256 with a grip and a trigger 1258. A barrel 1252 protrudes from a second grip 1254. A slidable charging handle 1262 is operated to load ammunition into a firing chamber of the firearm 1250. If the firearm 1250 is an actual firearm, element 1260 would be a replaceable magazine holding ammunition. If the firearm 1250 is a firearm simulator, the element 1260 could be a replaceable power supply.

Regardless of whether the firearm 1250 is an actual firearm or a firearm simulator, a recoil module 1270 is integrally mounted within the firearm 1250. The recoil module 1270 can include one or more linear motors, as described above. For example, the recoil module could be one like the ones described above in connection with FIGS. 9, 10A-B and 11A-B.

If the firearm 1250 is a firearm simulator, the recoil module 1270 would be used to generate simulated recoil forces like the ones a user would feel when firing a round of live ammunition for purposes of conducting training. If the firearm 1250 is an actual firearm, the recoil module 1270 could still be used to generate simulated recoil forces during training exercises so that live ammunition need not be fired to conduct the training exercises. However, the recoil module 1270 might also be used to generate forces that fully or partially cancel or counteract one or more of the force components that are generated when firing a live round of ammunition.

FIG. 13 illustrates a second embodiment of a firearm or firearm simulator 1300. The firearm/firearm simulator 1300 also includes a first handle 1356 with a grip and a trigger 1358. A barrel 1352 protrudes from a second grip 1354. A slidable charging handle 1362 is operated to load ammunition into a firing chamber of the firearm 1300. If the firearm 1300 is an actual firearm, element 1360 would be a replaceable magazine holding ammunition. If the firearm 1300 is a firearm simulator, the element 1360 could be a replaceable power supply.

In this embodiment, a recoil module 1370 is externally mounted on the top of the firearm/firearm simulator 1300. While the embodiment shown in FIG. 13 shows the recoil module 1370 mounted on the top of the firearm/firearm simulator 1300, the recoil module 1370 could be mounted at other locations on the firearm. For example, the recoil module 1370 could be mounted to the underside of the second grip 1354.

Externally mounting the recoil module 1370 can have multiple advantages over an internally mounted recoil module 1270 as shown in FIG. 12. First, it can be easier to externally mount and replace the recoil module 1370, as opposed to internally mounting a recoil module. This means a first type of recoil module configured to generate a first type or range of recoil forces can be easily replaced with a second recoil module 1370 configured to generate a second type or range of recoil forces. This makes it easy to quickly reconfigure a firearm simulator or an actual firearm to simulate different types of firearms or to simulate the firing of different types of ammunition.

Second, an externally mounted recoil module 1370 could be easily added to an existing actual firearm-meaning there need be no provisions within the firearm for receiving an internally mounted recoil module 1270. Also, the externally mounted recoil module 1370 could be mounted to existing mounting elements on the actual firearm, such as mounting elements designed to receive an optical scope or a sighting mechanism, or mounting elements configured to receive a grenade launcher or other ancillary devices.

When the recoil module 1370 is externally mounted, the size and shape of the recoil module is less constrained than if the recoil module is to be internally mounted, like the recoil module 1270 shown in FIG. 12. This may make it possible to include more linear motors or more components in an externally mounted recoil module 1370 as opposed to an internally mounted recoil module 1270.

Moreover, if an externally mounted recoil module 1370 incorporates a replaceable power supply in the form or a battery or a capacitor module, it would be easier to access and replace the power supply when the recoil module 1370 is externally mounted on the firearm/firearm simulator 1300.

As with the embodiment shown in FIG. 12, if the firearm 1300 is a firearm simulator, the recoil module 1370 would be used to generate simulated recoil forces like the ones a user would feel when firing a round of live ammunition for purposes of conducting training. If the firearm 1300 is an actual firearm, the recoil module 1370 could still be used to generate recoil forces during training exercises so that live ammunition need not be fired to conduct the training exercises. However, the recoil module 1370 might also be used to generate forces intended to partially or fully cancel or counteract one or more of the force components that are generated when firing a live round of ammunition.

The location at which the recoil module 1370 is mounted on the firearm simulator 1300 could change depending on what forces the recoil module 1370 is intended to simulate or to cancel. For example, the recoil module 1370 could be mounted at the top of the body of the firearm 1300 if the recoil module 1370 is intended to simulate the recoil forces the user would feel when firing live rounds of ammunition, or if the recoil module 1370 is to be used to generate forces that oppose or cancel the recoil forces generated by firing a round of live ammunition. If the recoil module 1370 is intended to simulate the forces the user would feel when launching a rocket propelled grenade from a grenade launcher mounted under the barrel 1352, the recoil module 1370 could instead be mounted on the second grip 1354 under the barrel 1352. Similarly, if the recoil module 1370 is intended to be used to oppose or cancel the recoil forces that are generated when firing a rocket propelled grenade from a grenade launcher mounted under the barrel 1352, the recoil module 1370 could be mounted somewhere on the front end of the firearm 1300, such as along or under the second grip 1354.

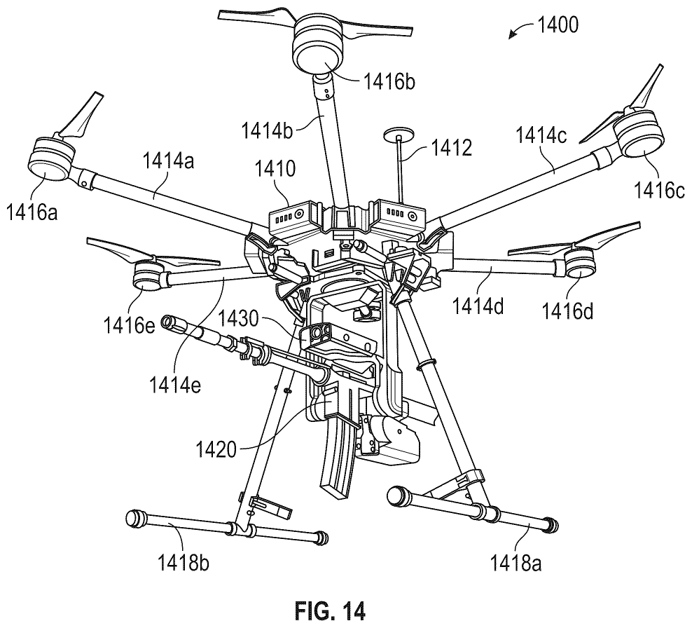

FIG. 14 illustrates a flying drone 1400 that incorporates a firearm 1420. The drone includes a main body 1410 that would incorporate a power supply and various electronics modules that control the operation of the drone and that communicate with a drone operator. A camera and recording mechanisms may also be mounted to the main body 1410 so that an operator can see what is within the field of view of the drone 1400. Additionally, various other sensing systems could be mounted to the main body 1410, such as a laser-based time-of-flight ranging system, a laser imaging system, a laser imaging, detecting and ranging (LIDAR) system, a traditional radar system, a mm Wave radar system, any combination of these systems and any other detecting and imaging systems that are developed in the future. An antenna 1412 mounted to the main body 1410 is used to facilitate radio communications between the drone and a drone operator. The drone also includes a plurality of arms 1414a-1414e, upon which are mounted a corresponding plurality of motor/propeller assemblies 1416a-1416e. Two landing struts 1418a, 1418b extend from beneath the main body 1410.

The firearm 1420 can be a conventional firearm that is simply mounted to the underside of the main body 1410. Alternatively, the firearm could be a specially designed firearm 1420 that is configured for use on a flying drone. Firearms designed for use on a flying drone could be made from special low-weight materials that withstand the forces of firing live rounds of ammunition, but which are not otherwise hardened to withstand the impacts and forces often experienced by hand-held firearms used by military and police forces. A firearm designed for use on a flying drone also need not include all of the hand hold elements or a trigger that are needed for manually operated firearms. Further, a firearm designed for use on a flying drone could have an entirely different triggering mechanism that is designed to be actuated by an electrical firing signal. Also, the ammunition feeding mechanism could be entirely different, and designed to feed ammunition to the firing chamber of the firearm 1420 from above, where the main body 1412 of the drone 1400 is located.

Regardless of the type of firearm 1420 attached to the drone 1400, a recoil module could be provided on either an element of the flying drone 1400, such as the main body 1410, or on the firearm 1420. In the embodiment shown in FIG. 14, a recoil module 1430 is mounted to the top of the firearm 1420. When a recoil module is mounted to the firearm 1420, it could be mounted at various different locations on the firearm 1420 to accomplish various different purposes, as discussed above. As also discussed above, a recoil module could also be internally mounted within the firearm 1420.

The recoil module 1430 could be configured to simulate the recoil forces that are generated when the firearm 1420 fires a live round of ammunition. This would provide a drone operator with experience about how to guide the drone while firing the firearm. One would expect the recoil forces generated when firing live rounds of ammunition to significantly affect the position and tilt orientation of the drone. Thus, causing a recoil module 1430 to generate recoil forces that mimic the forces generated when firing live rounds of ammunition could be an effective way to help train the drone operator.

If the recoil module 1430 is to generate forces that mimic the forces generated by firing a live round of ammunition, it may be best to have the recoil module 1430 mounted on or in the firearm 1420, as opposed to on the main body 1410 of the drone 1400, as that would provide a more accurate representation of how firing a live round of ammunition would affect the position and tilt attitude of the drone 1400.

A recoil module 1430 mounted on the drone 1400 or a firearm 1420 attached to the drone 1400 could also be used to cancel or counteract the forces generated when firing a live round of ammunition. This could assist the drone operator in keeping the firearm 1420 pointed at a target while firing live rounds of ammunition from the firearm 1420.

If a recoil module 1430 is to be used to cancel or counteract the forces generated when firing live rounds of ammunition from the firearm 1420, the recoil module 1430 could be located on the firearm 1420 or on an element of the drone 1400.

In an alternate embodiment not depicted in FIG. 14, a first recoil module 1430 could be provided on or in the firearm 1420 or attached to the drone 1400, and a second recoil module could be attached to an element of the drone itself 1400. One of the first and second recoil modules could be used to generate recoil forces that simulate the forces that are generated when firing rounds of live ammunition and the second recoil module could be used to cancel or counteract the forces generated when firing rounds of live ammunition. Alternatively, both recoil modules could be used to simulate the forces that would be generated by firing live rounds of ammunition. Or, alternately, both recoil modules could be used to counteract or cancel the forces that are generated when firing live rounds of ammunition from a firearm attached to the drone 1400.

The drone 1400, firearm 1420 and recoil module 1430 depicted in FIG. 14 are but one example of how a recoil module could be used in connection with a drone that incorporates a firearm. The actual details of the drone, the firearm attached to the drone and the recoil module that is employed could vary greatly from what is depicted in FIG. 14. Thus, the depiction in FIG. 14 and the accompanying description provided above should in no way be considered limiting.

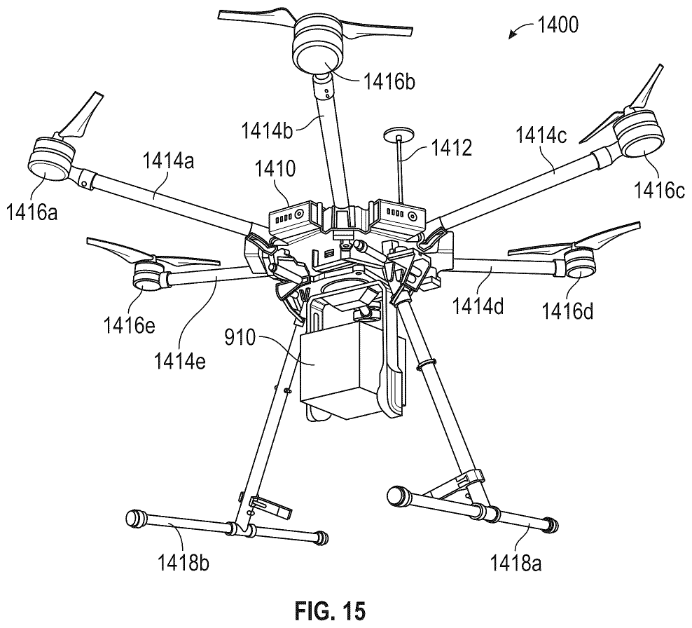

FIG. 15 depicts a drone similar to the one depicted in FIG. 14. However, in the embodiment depicted in FIG. 15, a linear actuator unit 910 that incorporates one or more linear motors is mounted to the main body 1410 of the drone 1400. The linear actuator unit 910 may contain one or more linear motors that each having a sliding mass that moves along axes oriented in three mutually perpendicular directions. In some embodiments, two or more of the linear motors may have sliding masses that move along axes arranged in the direction. For example, the linear actuator unit could include a total of six linear motors, where pairs of the linear motors have sliding masses that move along the same axes, resulting in two linear motors for each of three mutually perpendicular directions. Further, the linear motors could be arranged with the axes in the same planes or in different planes.

In either of the foregoing embodiments, a sensing device mounted on the main body could be configured to detect and track objects moving within the field of view of the sensing device. For example, mmWave sensors (as are commonly used in the automotive industry) could be configured to detect and track incoming ballistic projectiles such as bullets or powered munitions such as missiles that are nearing the drone 1400.

When a drone 1400 is equipped with a linear actuator unit 910, either alone as in the embodiment in FIG. 15 or as part of a recoil module 1430 as in the embodiment in FIG. 14, the drone 1400 may respond to incoming fire by actuating the linear actuator unit 910 to produce forces that act on the main body 1410 of the drone 1400 to cause the drone or translate or rotate in order to move the drone 1400 out of the path of any incoming ballistic projectiles or powered munitions. Thus, the linear actuator unit 910 can be actuated to allow the drone 1400 to dodge incoming fire.

Although FIG. 15 depicts a linear actuator unit 910 essentially carried as part of a payload of the drone 1400, in alternate embodiments a linear actuator unit 910 and/or a recoil module 1430 may be directly incorporated into the main body 1410 of the drone 1400 so that the drone 1400 may carry another payload. The additional payload carried by the drone 1400 could be a firearm 1420, as depicted in FIG. 14. Moreover, the actual configuration details of such a drone 1400, the way in which a firearm is attached to the drone and/or the way in which a recoil module or a linear actuator unit is integrated could vary greatly from what is depicted in FIGS. 14 and 15. Thus, the depiction in FIGS. 14 and 15 as well as the accompanying description provided above should in no way be considered limiting.

In the case of detached firearms, a recoil module could be used to cancel or counteract the forces that are generated when firing a round of live ammunition from a firearm. The recoil module would typically be mounted on or in the firearm. In the case of a flying drone, a recoil module could again be used to cancel or counteract the forces that are generated when a firearm attached to the drone fires a round of live ammunition. Regardless, a calibration procedure making use of inertial sensors in the recoil module could be used to help determine how to actuate the recoil module to effectively counteract the forces that are generated when firing a live round of ammunition.

As depicted in FIG. 9, a recoil module 900 can include one or more inertial sensors 908. Those inertial sensors 908 are configured to generate signals that are indicative of movements or accelerations of one or more elements of the recoil module, or movements or accelerations of a housing of the recoil module. If the recoil module is attached to a firearm or firearm simulator, the signals generated by the inertial sensors 908 would be indicative of movements and/or accelerations of the firearm or firearm simulator. If the recoil module 900 is mounted to a flying drone, the signals generated by the inertial sensors 908 would be indicative of movements and/or accelerations of the flying drone.

To conduct a calibration procedure when a recoil module 900 is attached to an actual firearm, one would record the signals generated by the one or more inertial sensors 908 when one or more rounds of ammunition are fired from the actual firearm. The recorded signals would then be analyzed and used to determine how to actuate one or more linear motors of the linear actuator unit 910 of the recoil module 900 to counteract the forces that were generated when the round of live ammunition was fired. This could include an attempt to actuate the linear actuator unit 910 to counteract all of the forces that were generated when the live round of ammunition was fired, or only one or only a few of the components of the forces that were generated when the round of live ammunition was fired.

For example, firing a live round of ammunition could generate a first translational force component that tends to push the firearm backwards and a second rotational force component that tends to rotate the body of the firearm around its center of gravity, typically causing the front end of the barrel of the firearm to tilt upward. The inertial sensors 908 could sense each of these forces independently and generate two corresponding signals. Alternatively, the inertial sensors 908 could generate a single output signal that includes information about both of these force components.

The signals from the inertial sensors 908 would then be used to determine how to actuate one or more linear motors of a linear actuator unit 910 to cancel or counteract these forces. This could include actuating one or more linear motors to cancel or counteract only the backward translational force. Alternatively, this could include actuating one or more of the linear motors to cancel or counteract only the rotational force. In still other instances, this could include actuating one or more of the linear motors to cancel or counteract both the backwards translational force and the rotational force.

Regardless of how the linear motors of the linear actuator unit 910 are actuated, the signals generated by the inertial sensors 908 could be analyzed to help determine how to actuate the linear motors of the linear actuator unit 910 to achieve a desired cancellation or mitigation of the forces generated by firing a live round of ammunition.

Also, one could then do a second test firing of a live round of ammunition while the linear motors of the linear actuator unit 910 are selectively actuated in an attempt to cancel the forces generated by firing the second round of live ammunition. The signals output by the inertial sensors 908 could then be analyzed to determine how successful the actuation of the linear motors of the linear actuator unit 910 were in cancelling or mitigating the forces generated by the firing of the second round of ammunition. If an analysis of the signal(s) output by the inertial sensors 908 indicate that not all of the forces generated by firing the second round of live ammunition were effectively cancelled by the action of the linear actuator unit 910, small adjustments can be made to how the one or more linear motors of the linear actuator unit 910 are actuated to better cancel the forces generated by firing a live round of ammunition.

Either or both of the controller 902 and the linear actuator unit 910 of a recoil module 900 may be coupled to the trigger mechanism of a firearm or firearm simulator to which the recoil module 900 is attached. This will allow the linear actuator unit 910 to either be actuated to generate recoil forces that mimic the forces generated by firing a live round of ammunition or be actuated to cancel or counteract the forces generated by firing a live round of ammunition. In alternate embodiments, the recoil module 900 may include a trigger module 922 that is mounted to or incorporated within the recoil module 900 itself or a firearm or firearm simulator to which the recoil module 900 is attached. The trigger module 922 then generates a trigger signal that is communicated to either the controller 902 or the linear actuator unit 910 when the user pulls the trigger of the firearm or firearm simulator to which the recoil module 900 is mounted.

In alternate embodiments, it may not be necessary for the controller 902 and/or the linear actuator unit 910 to be coupled to the trigger of a firearm or firearm simulator or to a trigger module 922 to know when it is time to actuate the linear actuator unit 910. Instead, if the recoil module 900 is mounted to an actual firearm and it is being used to cancel or counteract the recoil forces generated when firing a live round of ammunition, the inertial sensors(s) 908 could generate a trigger signal when the inertial sensors 908 first begin to detect acceleration forces that indicate that the firearm is firing a live round of ammunition. In this case, the signal from the inertial sensor(s) 908 would be used to determine when to actuate the linear actuator unit 910 to cancel or counteract the recoil forces being generated by the firing of the live round of ammunition.

In the descriptions provided above, a recoil module can be mounted to an actual firearm or a flying drone that is attached to an actual firearm so that the recoil module can provide forces that cancel or counteract the forces generated by the firing of a live round of ammunition. In some embodiments, the recoil module can be configured to substantially cancel all the recoil forces that are generated by the firing of a live round of ammunition. In other instances, the recoil module could be configured not to cancel or completely counteract all of the recoil forces, but rather to reduce those recoil forces. Also, the recoil module can be configured to cancel or reduce only one aspect or component of the recoil forces, only selected ones of the recoil forces or substantially all of the recoil forces. The user interface 936 of the recoil module 900 may give the user control of which forces are counteracted, and the degree to which each of the recoil forces are reduced or canceled.

Some embodiments of the recoil module are configured such that the recoil module 900 can conduct a calibration procedure using the signals from one or more inertial sensors 908 to determine how to actuate a linear actuator unit 910 to cancel or reduce certain recoil forces that are generated by firing a live round of ammunition. The same recoil module may also be configured such that a signal or signals from one or more inertial sensors 908 are used to determine when the firearm is firing a live round of ammunition, and thus when to actuate the linear actuator unit 910 to cancel or reduce the recoil forces being generated by firing the live round of ammunition. Such a recoil module could be very easily added to any existing firearm to provide forces that reduce or cancel the recoil forces generated by firing a live round of ammunition. There would be no need to integrate or connect the recoil module to the triggering mechanism of the firearm. Also, there would be no need to know, ahead of time, how to actuate the linear actuator unit 910 to reduce or cancel the recoil forces because that information would be developed by conducting one or more calibrations operations as described above.

What is claimed is:

1. A recoil module configured to be mounted to a firearm, comprising:
a linear actuator unit that includes at least one linear motor;
at least one inertial sensor configured to generate a signal indicative of movement of the firearm to which the recoil module is attached; and
at least one controller coupled to the at least one inertial sensor and configured to drive the linear actuator unit such that the linear actuator unit generates at least one force which partially or substantially fully cancels at least one recoil force that is produced when the firearm fires a round of live ammunition.

2. The recoil module of claim 1, wherein the at least one controller is configured to perform a calibration procedure that includes:
monitoring at least one first signal output from the at least one inertial sensor when the firearm fires a first live round of ammunition; and
generating, based on the monitored at least one signal output from the at least one inertial sensor, a first drive signal that is configured to drive the linear actuator unit such that the linear actuator unit generates at least one force which partially or substantially fully cancels at least one recoil force that is produced when the firearm fires a round of live ammunition.

3. The recoil module of claim 2, wherein the at least one signal output by the at least one inertial sensor is used by the at least one processor to determine when to apply the first drive signal to the linear actuator unit such that the linear actuator unit generates at least one force which partially or substantially fully cancels at least one recoil force that is produced when the firearm fires a round of live ammunition.

4. The recoil module of claim 2, wherein the at least one signal output by the at least one inertial sensor is used by the at least one processor to determine the configuration of the first drive signal that can be applied to the linear actuator unit such that the linear actuator unit generates at least one force which partially or substantially fully cancels at least one recoil force that is produced when the firearm fires a round of live ammunition.

5. The recoil module of claim 4, wherein the calibration procedure performed by the at least one controller further comprises:
causing the first drive signal to be applied to the linear actuator unit at approximately the same time that the firearm fires a second round of ammunition;
monitoring at least one second signal output from the at least one inertial sensor when the firearm fires the second live round of ammunition and the first drive signal is applied to the linear actuator unit; and
determining, based on the monitored at least one second signal output from the at least one inertial sensor, a configuration of a second drive signal that can be used to drive the linear actuator unit such that the linear actuator unit generates at least one force which partially or substantially fully cancels at least one recoil force that is produced when the firearm fires a round of live ammunition.

6. The recoil module of claim 2, wherein the linear actuator unit comprises:
a first linear motor having a sliding mass that moves in a first axial direction; and
s second linear motor having a sliding mass that moves in a second axial direction, wherein the first and second linear motors are arranged such that the first axial direction is not aligned with the second axial direction.

7. The recoil module of claim 6, wherein the first and second linear motors are arranged such that the first axial direction is substantially perpendicular to the second axial direction.

8. The recoil module of claim 6, wherein the first and second linear motors are arranged such that the first axial direction is in a different plane than the second axial direction.

9. The recoil module of claim 6, wherein the linear actuator unit further comprises a third linear motor having a sliding mass that moves in a third axial direction, wherein the first, second and third axial directions are all mutually perpendicular.

10. The recoil module of claim 2, wherein the inertial sensor outputs one or more signals that are indicative of movement of the firearm to which the recoil module is attached in two or more different linear directions.

11. The recoil module of claim 10, wherein the inertial sensor outputs one or more signals that are indicative of movement of the firearm to which the recoil module is attached in two or more linear directions and around at least one rotational axis.

12. A recoil module configured to be mounted to a flying drone, comprising:
a linear actuator unit that includes at least one linear motor;
at least one inertial sensor configured to generate a signal indicative of movement of the flying drone to which the recoil module is attached; and
at least one controller coupled to the at least one inertial sensor and configured to drive the linear actuator unit such that the linear actuator unit generates at least one force which partially or substantially fully cancels at least one recoil force that is produced when a firearm attached to the flying drone fires a round of live ammunition.

13. The recoil module of claim 12, wherein the at least one controller is configured to perform a calibration procedure that includes:
monitoring at least one first signal output from the at least one inertial sensor when the firearm attached to the flying drone fires a first round of live ammunition; and
generating, based on the monitored at least one signal output from the at least one inertial sensor, a first drive signal that is configured to drive the linear actuator unit such that the linear actuator unit generates at least one force which partially or substantially fully cancels at least one recoil force that is produced when the firearm attached to the flying drone fires a round of live ammunition.

14. The recoil module of claim 13, wherein the at least one signal output by the at least one inertial sensor is used by the at least one processor to determine when to apply the first drive signal to the linear actuator unit such that the linear actuator unit generates at least one force which partially or substantially fully cancels at least one recoil force that is produced when the firearm attached to the flying drone fires a round of live ammunition.

15. The recoil module of claim 13, wherein the at least one signal output by the at least one inertial sensor is used by the at least one processor to determine the configuration of the first drive signal that can be applied to the linear actuator unit such that the linear actuator unit generates at least one force which partially or substantially fully cancels at least one recoil force that is produced when the firearm attached to the flying drone fires a round of live ammunition.

16. The recoil module of claim 15, wherein the calibration procedure performed by the at least one controller further comprises:
causing the first drive signal to be applied to the linear actuator unit at approximately the same time that the firearm attached to the flying drone fires a second round of live ammunition;
monitoring at least one second signal output from the at least one inertial sensor when the firearm fires the second round of live ammunition and the first drive signal is applied to the linear actuator unit; and
determining, based on the monitored at least one second signal output from the at least one inertial sensor, a configuration of a second drive signal that can be used to drive the linear actuator unit such that the linear actuator unit generates at least one force which partially or substantially fully cancels at least one recoil force that is produced when the firearm attached to the flying drone fires a round of live ammunition.

17. A recoil module configured to be mounted to a flying drone, comprising:
a linear actuator unit that includes at least one linear motor;
at least one inertial sensor configured to generate a signal indicative of movement of the drone to which the recoil module is attached; and
at least one controller coupled to the at least one inertial sensor and configured to drive the linear actuator unit such that the linear actuator unit generates at least one force which causes the drone to translate or rotate while flying.

18. The recoil module of claim 17, wherein the at least one controller is configured to drive the linear actuator unit to partially or substantially fully cancels at least one recoil force that is produced when a firearm attached to the drone fires a round of live ammunition.

19. The recoil module of claim 18, wherein the at least one controller is configured to perform a calibration procedure that includes:
monitoring at least one first signal output from the at least one inertial sensor when the firearm fires a first live round of ammunition; and
generating, based on the monitored at least one signal output from the at least one inertial sensor, a first drive signal that is configured to drive the linear actuator unit such that the linear actuator unit generates at least one force which partially or substantially fully cancels at least one recoil force that is produced when the firearm fires a round of live ammunition.

20. The recoil module of claim 18, wherein the at least one signal output by the at least one inertial sensor is used by the at least one processor to determine when to apply the first drive signal to the linear actuator unit such that the linear actuator unit generates at least one force which partially or substantially fully cancels at least one recoil force that is produced when the firearm fires a round of live ammunition.

21. The recoil module of claim 18, wherein the at least one signal output by the at least one inertial sensor is used by the at least one processor to determine the configuration of the first drive signal that can be applied to the linear actuator unit such that the linear actuator unit generates at least one force which partially or substantially fully cancels at least one recoil force that is produced when the firearm fires a round of live ammunition.

22. The recoil module of claim 21, wherein the calibration procedure performed by the at least one controller further comprises:
causing the first drive signal to be applied to the linear actuator unit at approximately the same time that the firearm fires a second round of ammunition;
monitoring at least one second signal output from the at least one inertial sensor when the firearm fires the second live round of ammunition and the first drive signal is applied to the linear actuator unit; and
determining, based on the monitored at least one second signal output from the at least one inertial sensor, a configuration of a second drive signal that can be used to drive the linear actuator unit such that the linear actuator unit generates at least one force which partially or substantially fully cancels at least one recoil force that is produced when the firearm fires a round of live ammunition.

23. The recoil module of claim 18, wherein the linear actuator unit comprises:
a first linear motor having a sliding mass that moves in a first axial direction; and
s second linear motor having a sliding mass that moves in a second axial direction, wherein the first and second linear motors are arranged such that the first axial direction is not aligned with the second axial direction.

24. The recoil module of claim 23, wherein the first and second linear motors are arranged such that the first axial direction is substantially perpendicular to the second axial direction.

25. The recoil module of claim 23, wherein the first and second linear motors are arranged such that the first axial direction is in a different plane than the second axial direction.

26. The recoil module of claim 23, wherein the linear actuator unit further comprises a third linear motor having a sliding mass that moves in a third axial direction, wherein the first, second and third axial directions are all mutually perpendicular.

27. The recoil module of claim 17, wherein the at least one controller receives an imaging signal from an imaging device mounted on the drone, and wherein the at least one controller is configured to analyze the imaging signal to identify a trajectory of an object that is moving toward the drone, and wherein the at least one controller is configured to drive the linear actuator unit such that the linear actuator unit generates at least one force which causes the drone to translate or rotate while flying in order to avoid the identified object.

28. The recoil module of claim 27, wherein the imaging signal is received from a video camera mounted on the drone.

29. The recoil module of claim 17, wherein the at least controller receives an object trajectory signal from one or more sensors attached to the drone, wherein the object trajectory signal is indicative of a trajectory of an object that is moving toward the drone, and wherein the at least one controller is configured to drive the linear actuator unit such that the linear actuator unit generates at least one force which causes the drone to translate or rotate while flying in order to move the drone out of the trajectory of the object.
